(19) United States
(12) Patent Application Publication
(10) Pub. No.: US 2011/0088901 A1
(43) Pub. Date: Apr. 21, 2011

(54) Method for Plugging Wells

(76) Inventors: Larry Watters, Spring, TX (US); Fred Sabins, Montgomery, TX (US); Jeff Walters, Cypress, TX (US); Justin Arnold, Houston, TX (US)

(21) Appl. No.: 12/582,355

(22) Filed: Oct. 20, 2009

(51) Int. Cl. E21B 33/13; C09K 8/42; C09K 8/46

(52) U.S. Cl. 166/293; 166/285; 166/292

(57) ABSTRACT

A method of plugging wells wherein cementitious materials (like Portland cement) are formed into pellets that can be dumped or dropped into a well that is filled with an aqueous solution. The pellets will fall quickly to the bottom of the well or mechanically placed barrier, and over time, the pellets will loose their structure and release dry cementitious material into aqueous well fluid. The cementitious material will wet in the aqueous well fluid and then set to form an impermeable plug in the well.

### CROSS-REFERENCE TO RELATED APPLICATIONS

Not applicable

### STATEMENT REGARDING FEDERALLY SPONSORED RESEARCH OR DEVELOPMENT

Not applicable

### REFERENCE TO A “MICROFICHE APPENDIX”

Not applicable

### BACKGROUND OF THE INVENTION

1. Field of the Invention

The present invention relates to plugging or sealing abandoned wells. More particularly, the present invention relates to a method delivering a quantity of cementitious materials which has been formed into pellets into a well that is filled with an aqueous solution, so that over time, the pellets will loose their structure and release dry cementitious material into aqueous well fluid, then, after wetting, will set to form an impermeable plug in the well.

2. General Background of the Invention

There are a growing number of abandoned petroleum wells being identified that need to be plugged. The regulatory agencies responsible for the plugging of these abandoned wells do not have funding sufficient to plug all known abandoned wells, and the number continues to increase. The current methods used for well plugging are expensive as they involve mixing and circulating cement slurry in place from the surface, which requires a cementing unit (mixer and pump) and either a rig or coiled tubing unit on location to accomplish. A new technique has been developed for the plugging of abandoned petroleum wells, which is more economical and easier to accomplish.

The following U.S. patents are incorporated herein by reference:

TABLE

| U.S. PAT. NO. | TITLE | ISSUE DATE |
|---|---|---|
| 5,454,867 | Cement Agglomeration | Oct. 03, 1995 |
| 6,488,089 | Methods of Plugging Wells | Dec. 03, 2002 |
| 6,500,253 | Agglomeration of Hydraulic Cement | Dec. 21, 2002 |
| | Powder | |
| 7,156,174 | Contained Micro-particles for use in | Jan. 02, 2007 |
| | Well Bore Operations | |

### BRIEF SUMMARY OF THE INVENTION

The present invention provides new a method of plugging petroleum wells. Cementitious materials (like Portland cement) are formed into pellets that can be dumped or dropped into a well that is filled with an aqueous solution. The pellets will fall quickly to the bottom of the well or mechanically placed barrier, and over time, the pellets will loose their structure and release dry cementitious material into aqueous well fluid. For purposes of this application, in the preferred embodiment, the terms “mechanically placed barrier” would be defined as any material or device that can be introduced in a well at a specific height to create a barrier that will prevent further travel down the well; for example, a packer, bridge plug, pedal basket, sand plug, or barite plug; although there are other barriers that could be utilized. The cementitious material will wet in the aqueous well fluid and then set to form an impermeable plug in the well. This method eliminates the need for a rig or coiled tubing unit on location for the well plugging process. A wire line unit is still needed to tag cement plug to ensure it is hard and located at the proper depth in the well.

### DETAILED DESCRIPTION OF THE INVENTION

In the method of the present invention, cementitious pellets are dropped into an aqueous wellbore and after reaching the lowest travel point down the wellbore, over time, the pellets form an impermeable plug in the well.

First, it should be noted that the pellets have been formed using two different methods in the laboratory for demonstration purposes. However, any viable manufacturing method used for agglomerating and coating powders could be adapted to produce similar pellets. The first is by first mixing cementitious material with or without a small percentage of water (or other binder) until uniformly blended. The mixture is then placed in a die. The die consists of two metal plates that are 1-inch thick. The top plate has ¼-inch diameter holes drilled through it. The bottom plate has no holes. The cementitious material and water mixture is packed into the holes. Then, the die is placed into a hydraulic press, and a small piston is placed over the material in the hole. The piston is then pressed into the material with a force of 750-1500 pounds. This compresses the cementitious material into a pellet form which can be handled. A number of commercial pellet forming processes could be used to manufacture the pellets for field applications.

The second method to form a cement pellet is to utilize a fluidized bed system. A fluid bed system is used to granulate, or agglomerate, fine cement powders and coat the agglomerated particles. The machine completes the agglomeration by introducing a high flow of air through a bowl of powders. As the powder is being suspended, or fluidized, a binder is sprayed through a nozzle from either the bottom or top of the bowl. As the binder is sprayed into the bowl, the small powders begin to stick together, growing in size. The fluid bed system has several key parameters that can be adjusted depending on the application process. The parameters include; air flow, inlet air temperature, liquid pump speed, and nozzle air pressure. These parameters need to be adjusted for each individual project to produce the desired product. The process in which a coating is created on the particle is similar, except the spraying is done from the bottom through a Wurster insert. The Wurster insert creates a circular flow for the particles through a hollow cylindrical tube where the particles are sprayed, resulting in a more concentrated coating.

The material must remain in pellet form in order to fall down the well, in the aqueous well fluid, until the bottom or mechanically placed barrier is reached. A thin coating of degradable polymer can be applied to the pellets to add mechanical integrity and delay the release of cementitious material in the wellbore. The pellets can be coated by spraying a solution of low molecular weight degradable polymer, such as polylactic acid or other polyester, and a solvent onto the surface of the pellet. The pellets can also be dipped into a solution of a degradable polymer and a solvent. After the solvent evaporates, the pellets develop a stronger outer shell from the polymer coating. Multiple coatings of the degradable polymer solution can be applied to the pellets to increase mechanical integrity or delay the release of cementitious material.

The degradable polymer coating helps to control the release of cementitious material in the well fluid, which provides use in a wider temperature range. The molecular weight of the degradable polymer used to coat pellets can also be varied to apply process across a wide range of well conditions. Binders can be incorporated into the cement mix to help control the release of the cementitious material into the well fluid. Other additives can be incorporated into the cement to enhance the release of cementitious material into the well fluid. Two examples are gas generating materials (such as aluminum powder) or porous materials such as vermiculite.

The following experimental data supports the novelty and utility of the present invention.

### Experimental Data:

### Hydraulic Press Method

Lehigh Class A cement was mixed with 2% (by weight of cement) water. Approximately 1 gram of the cement mixture was placed into the ¼ inch diameter die and was compressed with a piston by a load of 750 pounds. The resulting pellets were ¼-inch diameter by ½ inch long cylinders.

The pellets were then dipped into a solution of a low molecular weight (approximately 25,000) polylactic acid (PLA) and acetone solution. The solution was 120% PLA by weight of acetone. After the acetone evaporated, the pellets were dipped into the solution again to achieve a thicker polymer coating.

Several pellets were then placed in the bottom of a test tube and fresh water was added to fill the test tube. The test tube was then placed into a heated water bath. The following procedure was tested with water bath temperatures of 120° F., 140° F., and 160° F. The pellets held their shape for a time greater than 1 hour, and then the cementitious material was released into the water. After 24 hours, a hard, impermeable cement plug had formed in the bottom of the test tubes at each of the above noted temperatures.

### Fluidized Bed Method

The bowl of the fluid bed system was loaded with 2000 grams of fine powder cement. The cement was fluidized by applying 20 m³/hour air flow through the bottom of the bowl. Once the bed was fluidized the PLA binding solution was sprayed at 10% of the motor speed for 30 minutes. This binding solution was created by combining 292 grams of low molecular weight PLA and 400 grams of 1,3 Dioxolane. After 30 minutes spraying time, the product grew to approximately 100 mesh. Air flow was increased to 25 m³/hour and the spraying was increased to 20% for 1 hour. After an hour and thirty minutes of spraying, the process was stopped and the material was pulled to evaluate.

The analysis of the material made utilizing the fluid bed system included; sieve analysis, settling test or fall rate through water, and compressive strengths of the cement plug formed.

The sieve analysis indicated that the majority of the material is between 12 and 30 mesh.

The fall rate of the cement pellet through a column of water was measured. The pellets fell at an average rate of 25 feet per minute. This is very beneficial considering the fall rate of fine cement powder was approximately foot per minute.

The compressive strength of the set cement was also tested. A plastic 2-inch cube mold was filled with 12 to 18 mesh cement pellets and water was added to fill pore spaces and cover the solid pellets. The cubes were placed in a heated water bath at 180° F. The compressive strength was measured after curing for 48 hours and it was 50 psi.

All measurements disclosed herein are at standard temperature and pressure, at sea level on Earth, unless indicated otherwise. All materials used or intended to be used in a human being are biocompatible, unless indicated otherwise.

The foregoing embodiments are presented by way of example only; the scope of the present invention is to be limited only by the following claims.

1. A method of plugging wells, comprising the steps of:
a. forming cementitious materials into pellets;
b. dropping the cementitious pellets into a well that is at least partially filled with an aqueous solution so that the pellets fall to the bottom of the well;
c. allowing the pellets to lose their structure and release dry cementitious material into the aqueous solution; and
d. allowing the cementitious material in the aqueous well to set and form an impermeable plug in the well.

2. The method in claim 1, wherein the cementitious material remains in pellet form in order to fall down the well in the aqueous well fluid, until the bottom is reached.

3. The method in claim 1, wherein binders are incorporated into the cement mix to help form pellets and control the release of cementitious material into well fluid.

4. The method in claim 3, wherein the binders are comprised of water soluble adhesive polymers, such as polyvinyl acetate or degradable polymers, such as polylactic acid.

5. The method in claim 1, further comprising the step of applying a thin coating of degradable polymer to the pellets prior to dropping the pellets into the well to add mechanical integrity and delay the release of cementitious material in the wellbore.

6. The method in claim 1, further comprising the step of coating the pellets with a solution of degradable polymer, such as polylactic acid or other polyester, and a solvent onto the surface of the pellet.

7. The method in claim 6, wherein multiple coatings of the degradable polymer solution can be applied to the pellets to increase mechanical integrity or delay the release of cementitious material.

8. The method in claim 6, wherein the degradable polymer coating helps to control the release of cementitious material in the well fluid, which provides use in a wider temperature range.

9. The method in claim 6, wherein the composition, molecular weight, and degree of crystallinity of the degradable polymer used to coat pellets can be varied to apply process across a wide range of well conditions.

10. The method in claim 1, wherein other additives of gas generating materials or porous materials can be incorporated into the cement to enhance the release of cementitious material into the well fluid.

11. The method in claim 10, wherein the gas generating material comprises aluminum powder.

12. The method in claim 10, wherein the porous material comprises vermiculite or perlite.

13. The method in claim 1, wherein the cement mixture contains Portland cement and other additives, such as strength stabilizers, fluid loss additives, free water control additives, accelerators, and set control additives commonly know to those skilled in the art.

14. The method in claim 1, wherein the bottom of the well comprises a mechanically placed barrier upon which the pellets form the plug in the well.

15. A method of plugging wells comprising the steps of:
a. forming cementitious materials into pellets;
b. applying a thin coating of degradable polymer to the pellets to add mechanical integrity and delay the release of cementitious material in a wellbore;
c. dropping coated cementitious pellets into the wellbore that is filled with an aqueous solution so that the pellets fall to the bottom of the well;
d. allowing the pellets to lose their structure and release dry cementitious material into the aqueous solution; and
e. allowing the cementitious material in the aqueous well to set and form an impermeable plug in the well.

16. The method in claim 15, further comprising the step of coating the pellets with a solution of low molecular weight degradable polymer, such as polylactic acid or other polyester, and a solvent onto the surface of the pellet.

17. The method in claim 15, further comprising the step of dipping into a solution of a degradable polymer and a solvent to develop a stronger outer shell from the polymer coating.

18. The method in claim 15, wherein the bottom of the well comprises a mechanically placed barrier upon which the pellets form the plug in the well.

19. A method of plugging wells comprising the steps of:
a. forming cementitious materials into pellets;
b. coating the pellets with a solution of low molecular weight degradable polymer, such as polylactic acid or other polyester, and a solvent onto the surface of the pellet;
c. dropping coated cementitious pellets into a well that is filled with an aqueous solution so that the pellets fall to a mechanically placed barrier placed in the well;
d. allowing the pellets to lose their structure and release dry cementitious material into the aqueous solution; and
e. allowing the cementitious material in the aqueous well to set and form an impermeable plug in the well at the level of the mechanically placed barrier.

20. The method in claim 19, further comprising the step of dipping the pellets into a solution of a degradable polymer and a solvent to develop a stronger outer shell from the polymer coating.

21. The method in claim 19, wherein multiple coatings of the degradable polymer solution are applied to the pellets to increase mechanical integrity or delay the release of cementitious material.

22. The method in claim 19, wherein other additives of gas generating materials or porous materials can be incorporated into the cement to enhance the release of cementitious material into the well fluid.

23. The method in claim 19, wherein the gas generating material comprises aluminum powder.

24. The method in claim 19, wherein the porous material comprises vermiculite.

25. The method in claim 19, wherein the pellets are formed from an hydraulic press method, comprising the steps of:
a. mixing cement with appropriate binder;
b. mechanically pressing the cement and binder mixture to form pellet of desired size; and
c. drying the pellets.

26. The method in claim 19, wherein the pellets were formed by fluidized bed method, comprising the steps of:
a. loading a bowl of the fluid bed system fine powder cement and other additives;
b. fluidizing the cement by applying air flow through the bottom of the bowl;
c. after the bed has been fluidized, spraying a binding solution into the fluidized cement and additive bed; and
d. allowing particle size to increase to desired size.
